(19) United States
(12) Patent Application Publication
(10) Pub. No.: US 2004/0050158 A1
(43) Pub. Date: Mar. 18, 2004

(54) Liquid level sensing gauge assembly and method of installation

(76) Inventor: R. Michael Webb, Eau Claire, WI (US)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/247,458

(22) Filed: Sep. 18, 2002

(51) Int. Cl. G01F 23/36

(52) U.S. Cl. 73/313; 340/623

(57) ABSTRACT

A liquid level gauge assembly that has particular utility for petroleum products has a threaded cylindrical projection that allows quick installation onto a storage tank. The gauge assembly operates by measuring the displacement of a float member through a filament that extends through a restrictive opening in the outer housing of the gauge assembly. An adapter is connected to the free end of the filament outside the outer housing. The opening is sized so that the adapter is prevented from passing therethrough, thus preventing the filament from retracting completely into the housing. The gauge assembly also includes an electronic level or volume monitoring system.

### BACKGROUND OF THE INVENTION

1. Field of the Invention

This invention relates to an improved gauge assembly for monitoring the level of fluid in a storage tank or like container, and to an improved, convenient method for installing such a gauge assembly.

2. Description of the Related Technology

A great variety of devices have been used to determine and provide indications of the liquid level in storage tanks and other such vessels. However, monitoring the level of storage tanks which contain petroleum products or other volatile liquids presents special requirements that have not been fully satisfied by the technology that is in common use today.

Petroleum products such as oil and gasoline contain viscous components that tend to coat any surface to which they are exposed. This effectively precludes the use of visual sight gauges for fluid level monitoring. The volatile nature of such fluids also makes their monitoring with electronic level sensing equipment more dangerous and otherwise problematic.

Float level gauges have been used in the past to monitor the level of petroleum-based products. Such a gauge is disclosed in U.S. Pat. No. 3,482,447 to Bennett. This device includes an analog gauge that is synchronized with an internal drum. Wrapped about the drum is a gauge line that is connected to a float element. The drum is biased in a first rotary direction by an elongated coil-type spring, which keeps the gauge line in tension. As the float element rises or falls in response to the level of the liquid within a storage tank, the analog display reflects the resultant rotation of the drum. Another mechanically based flow level gauge, disclosed in U.S. Pat. No. 5,144,836 to Webb advantageously is designed so as to keep installation time to a minimum while working on tanks that are already in operation, and to be quickly and easily calibrated to reflect the liquid level within a tank after it is installed. These gauges utilize an analog clocklike display having a first indicating hand that is calibrated to indicate inches and a second indicating hand that is calibrated to indicate feet. The gauge disclosed in the Webb patent has enjoyed significant commercial success because of these advantages and the reliable mechanical design. However, with the growing use of electronic and particularly digital electronic technology, there is a need to be able to electronically monitor fluid level within such storage tanks. Specifically, it is clear that there exists a need in the prior art for a liquid level gauge which is convenient to install, which can be quickly calibrated to reflect the level of liquid within a storage tank to which it is mounted, which is mechanically simple and inexpensive to manufacture, which protects the environment against escape of vapors from the storage tank and that is furthermore compatible for use in conjunction with electronic control system.

### SUMMARY OF THE INVENTION

Accordingly, it is an object of the invention to provide a system and method for a liquid level gauge which is convenient to install, which can be quickly calibrated to reflect the level of liquid within a storage tank to which it is mounted, which is mechanically simple and inexpensive to manufacture, which protects the environment against escape of vapors from the storage tank and that is furthermore compatible for use in conjunction with an electronic control system.

In order to achieve the above and other objects of the invention, a gauge assembly for measuring the amount of a liquid in a storage tank or like container includes, according to a first aspect of the invention, an outer housing, a float member, a filament connected to the float member, a spool member rotatably mounted within the outer housing, the spool member being constructed and arranged to pay out the filament, analog indicator structure on the outer housing for displaying a value which corresponds to the rotary position of the spool member; and electronic detection structure for detecting a position of the analog indicator structure, whereby the gauge assembly is further compatible with an electronic monitoring system.

According to a second aspect of the invention, a system for monitoring the amount of a liquid in a storage tank or like container includes a storage tank; a float member mounted for movement within the storage tank, an analog display, mechanical linkage structure for controlling the analog display in response to a position of the float member, electronic detection structure, mechanically connected to the mechanical linkage structure, for detecting a position of the analog indicator structure; and monitoring structure for monitoring information received from the electronic detection structure.

According to a third aspect of the invention, a method for monitoring the amount of a liquid in a storage tank or like container includes steps of mounting a mechanical level gauge to a storage tank; calibrating the level gauge mechanically while simultaneously calibrating electronic detection structure that is mechanically connected to the mechanical level gauge; using the level gauge to monitor the amount of a liquid in the storage tank; and using the electronic detection structure to monitor the amount of a liquid within the storage tank.

A kit for monitoring the amount of liquid in a storage tank according to a fifth aspect of the invention includes a mechanical gauge having a mechanical display that is indicative of the fill level of the storage tank; an electronic sensor that is mechanically connected to the mechanical gauge; and a computer interface device for coupling the electronic sensor to a personal computer.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view of a gauge assembly constructed according to a preferred embodiment of the invention shown in its mounted position upon a storage tank;

FIG. 2 is a partially fragmented cross-sectional view through the gauge assembly depicted in FIG. 1 and the storage tank;

FIG. 3 is another cross-sectional view of the gauge assembly that is depicted in FIGS. 1 and 2;

FIG. 4 is a diagrammatical view depicting a portion of the gear train in the gauge that is constructed according to FIGS. 1-3; and

FIG. 5 is a schematic depiction of another portion of the preferred embodiment of the invention; and.

### DETAILED DESCRIPTION OF THE PREFERRED EMBODIMENT(S)

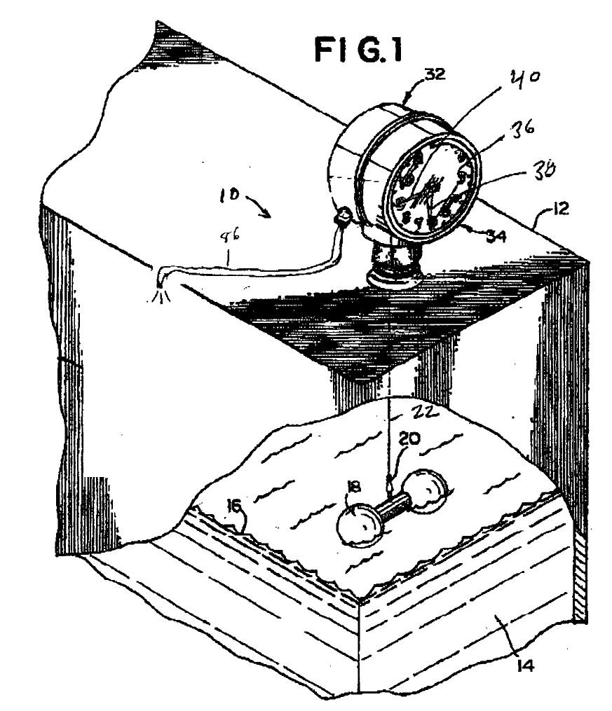

Referring now to the drawings, wherein like reference numerals designate corresponding structure throughout the views, and referring in particular to FIG. 1, a gauge assembly 10 for a storage tank 12 of the type that is adapted to be filled with a liquid product 14, such as a petroleum product, monitors a fill level 16 by utilizing a float member 18 that is constructed and arranged to float on an upper surface of the liquid product 14. As may be seen in FIG. 1, gauge assembly 10 includes a filament 22 having a distal end 20 that is connected to float member 18, preferably by a clip mechanism 80, as may be seen in FIG. 3.

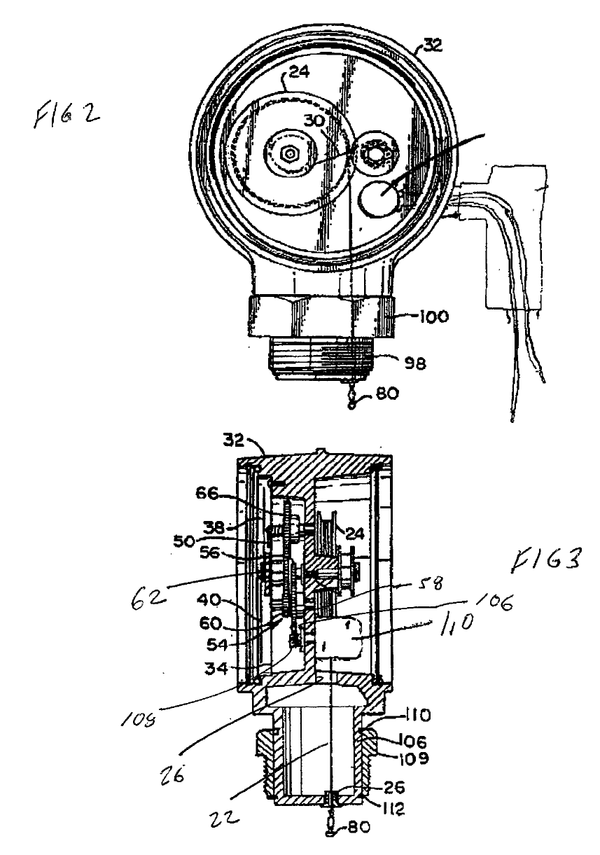

Referring now to FIG. 3, it will be seen that filament 22 passes through an opening 26 that is defined in a housing 32 of gauge assembly 10. Filament 22 is wound about a drum 24 that is mounted for rotation within the housing 32, as is shown in both FIGS. 2 and 3. A biasing mechanism 28 is provided for biasing the drum 24 in a first rotary direction that will wind the filament 22 onto drum 24, so that biasing mechanism 28 will tend to pull float member 18 toward housing 32, thereby keeping filament 22 taut for purposes of accuracy. Preferably, biasing mechanism 28 includes a constant force spring 30.

Looking now to FIG. 1, it will be seen that gauge assembly 10 preferably includes a clock-type face having distance indicia 36 marked therearound that is in a base-twelve numbering system to represent feet and inches, rather than hours and minutes. A small hand 38 is mounted to traverse clock face 34 to represent feet, and a large hand is also mounted to traverse clock face 34 to represent inches. Both small and large hands 38, 40 are mechanically connected to drum 24 via a gear train 54, which will be described in greater detailed below.

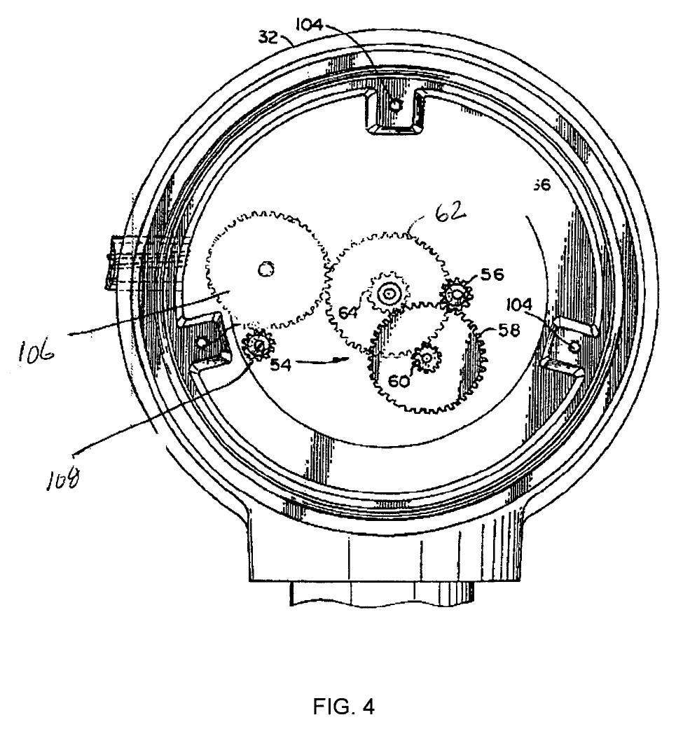

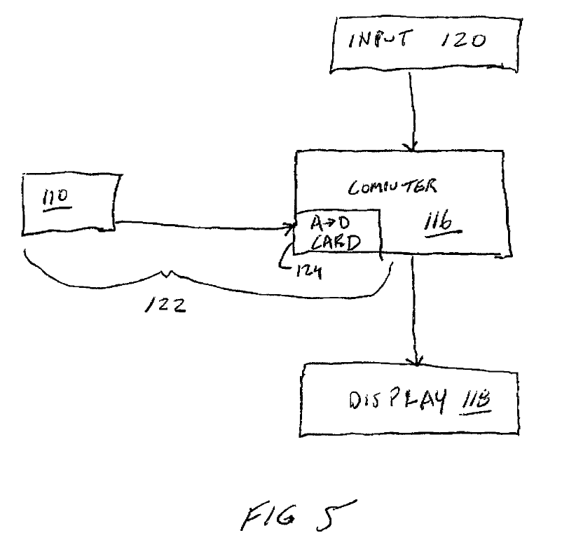

As may be seen best in FIGS. 2-4, gear train 54 includes a first pinion 56 that is mechanically connected to drum 24 to rotate with drum 24. As may best be seen in FIG. 4, a second pinion 58 is positioned to be driven by first pinion 56. A third pinion 60 that is smaller than second pinion 58 is mounted coaxially with second pinion 58 to rotate with second pinion 58. A fourth pinion 62 is connected to rotate with small hand 38 on clock face 34. A fifth pinion 64 is connected to rotate with large hand 40 on clock face Fourth pinion 62 is larger than fifth pinion 64, and is engaged to be driven by third pinion 60. Fifth pinion 64 is engaged to be driven by second pinion 58. The different reduction ratios provided by third pinion 60 and fourth pinion 62, and second pinion 58 and fifth pinion 64, respectively, will ensure that large hand 40 will circumferentially traverse clock face 34 twelve times for each time that small hand 38 circumferentially traverses clock face 34.

As is shown in FIG. 3, an electronic detection device 110 is mechanically coupled to gear train 54 by a mechanical coupling arrangement that includes an idler gear 106, which is driven by fourth pinion 62, and a pinion 108 that is driven by idler gear 106. This mechanical coupling could be effected in any one of a plurality of different ways, all of which fall within the ambit of the invention. Electronic detection device 110 in the preferred embodiment is a rotary position dependent device, most preferably a multirotational potentiometer. Alternatively, electronic detection device 110 could be constructed as a variable capacitor, a variable inductor, or any other position dependent device having variable electronic properties.

As may be seen in FIG. 5, electronic detection device 110 is constructed and arranged to communicate electronically with an analog to digital converter PC card 124, which is installed within a personal computer 116 that includes a display device 118, such as a monitor, and an input device 120, such as a keyboard or mouse. As may be seen in FIG. 1, a multiple conductor cable 86 contains wires that connect the electronic detection device 111 and the personal computer 116. Gauge assembly 10 and the analog to digital computer card 124 are preferably sold together as a kit 122 to customers together with software for converting the digital output of the analog to digital card 124 into information as to the fill status of the aboveground storage tank that will be displayed by the personal computer 116. The electrical signals within the cable 86 are preferably kept at current and voltage levels that are known in the industry as “intrinsically safe,” whereby the risk of igniting flammable liquids or vapors in kept to a minimum.

Personal computer 116 preferably runs the Windows operating system, and the software that is provided with the kit 122 permits an operator to enter information such as the date on which the aboveground tank has been filled and the identity of the fuel in the tank, such as, for example, diesel or gasoline. After installation of the gauge 10 into the aboveground storage tank and installation of the analog to digital card 124 and the software into the personal computer 116, the software will initially ask an operator to enter information that is relevant to the tank that is to be monitored, such as the height and length of the tank. The software will provide an intuitive display of the fuel level within the tank, and will indicate to an operator when the fuel level is critically low or when the tank is overfilled. Fuel levels may also be displayed quantitatively, such as in liters or gallons.

In operation, electronic detection device 110 will be monitored by the central processing unit 116, with the electronic value indicated by the electronic detection device 110 being detectable by the central processing unit 116 as indicative of a particular level or volume of fluid within the tank 12. In order to calibrate this electronic monitoring system, an operator needs only to calibrate the manual system as described above, adjusts the position of the clock gauge to a known value, and enter the known value using the input device 120. As the system is used, this electronic monitoring system can verify the accuracy of the clock gauge and can further be used for remote detection of the volume level, such as by a remote service center facility that is located several miles from the tank 12.

The invention further includes a process of retrofitting existing mechanical gauges with electronic devices 110 according to the invention.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A gauge assembly for measuring the amount of a liquid in a storage tank or like container, comprising:
an outer housing;
a float member;
a filament connected to said float member;
a spool member rotatably mounted within said outer housing, said spool member being constructed and arranged to pay out said filament;
analog indicator means on said outer housing for displaying a value which corresponds to the rotary position of said spool member; and
electronic detection means for detecting a position of said analog indicator means, whereby said gauge assembly is further compatible with an electronic monitoring system.

2. A gauge assembly according to claim 1, wherein said analog indicator means comprises a clocklike display having hand members.

3. A gauge assembly according to claim 1, wherein said analog indicator means further comprises a gear train that is mechanically interposed between an analog display and said spool member, and wherein said electronic detection means is mechanically coupled to said gear train.

4. A gauge assembly according to claim 3, wherein said electronic detection means includes no independent power supply.

5. A gauge assembly according to claim 4, wherein said electronic detection means comprises a position dependent device having variable electrical properties.

6. A gauge assembly according to claim 5, wherein said electronic detection means comprises a potentiometer.

7. A gauge assembly according to claim 5, wherein said electronic detection means comprises a variable capacitor.

8. A gauge assembly according to claim 5, wherein said electronic detection means comprises a variable inductor.

9. A gauge assembly according to claim 5, wherein said position dependent device is a rotary position dependent device.

10. A gauge assembly according to claim 9, wherein said rotary position dependent device is multirotational.

11. A system for monitoring the amount of a liquid in a storage tank or like container, comprising:
a storage tank;
a float member mounted for movement within said storage tank;
an analog display;
mechanical linkage means for controlling said analog display in response to a position of said float member;
electronic detection means, mechanically connected to said mechanical linkage means, for detecting a position of said analog indicator means; and
monitoring means for monitoring information received from said electronic detection means.

12. A system according to claim 11, wherein said electronic detection means includes no independent power supply.

13. A system according to claim 12, wherein said electronic detection means comprises a position dependent device having variable electrical properties.

14. A system according to claim 13, wherein said electronic detection means comprises a potentiometer.

15. A gauge assembly according to claim 13, wherein said electronic detection means comprises a variable capacitor.

16. A gauge assembly according to claim 13, wherein said electronic detection means comprises a variable inductor.

17. A gauge assembly according to claim 13, wherein said position dependent device is a rotary position dependent device.

18. A gauge assembly according to claim 17, wherein said rotary position dependent device is multirotational.

19. A method for monitoring the amount of a liquid in a storage tank or like container, comprising steps of:
(a) mounting a mechanical level gauge to a storage tank;
(b) calibrating the level gauge mechanically while simultaneously calibrating electronic detection structure that is mechanically connected to the mechanical level gauge;
(c) using the level gauge to monitor the amount of a liquid in the storage tank; and
(d) using the electronic detection structure to monitor the amount of a liquid within the storage tank.

20. A kit for monitoring the amount of liquid in a storage tank, comprising:
a mechanical gauge having a mechanical display that is indicative of the fill level of the storage tank;
an electronic sensor that is mechanically connected to said mechanical gauge; and
a computer interface device for coupling said electronic sensor to a personal computer.

21. A kit according to claim 20, wherein said computer interface device comprises a PC card.

22. A kit according to claim 21, wherein said PC card comprises an analog to digital PC card.

23. A kit according to claim 20, further comprising software for the personal computer.

24. A kit according to claim 23, wherein said software is constructed and arranged to process information that is received from said computer interface device.
